(19) United States
(12) Patent Application Publication
(10) Pub. No.: US 2006/0210118 A1
(43) Pub. Date: Sep. 21, 2006

(54) Personal identification apparatus

(76) Inventors: Koji Kobayashi, Tokyo (JP); Atsushi Katsumata, Tokyo (JP); Kosaku Tohda, Kanagawa (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/364,944

(22) Filed: Feb. 28, 2006

(30) Foreign Application Priority Data
Mar. 1, 2005 (JP) 055779/2005

(51) Int. Cl. G06K 9/00

(52) U.S. Cl. 382/115

(57) ABSTRACT

A personal identification apparatus includes an image sensing device, collation determination circuit, and recognition unit. The image sensing device senses at least part of the face of an identification target. The collation determination circuit collates image pattern information output from the image sensing device with registered pattern information of at least part of the face and outputs an authentication result. The recognition unit causes the identification target to recognize that at least part of the face is located in the focus range of the image sensing device. The recognition unit includes a point source, and a light-shielding member. The light-shielding member is arranged between the point source and the identification target to make the point source invisible or visible from the identification target only when at least part of the face is located in the focus range of the image sensing device and make the point source visible or invisible at another portion.

### BACKGROUND OF THE INVENTION

The present invention relates to a personal identification apparatus which identifies an identification target by using the face or part of the face of the identification target.

Various kinds of personal identification apparatuses for identifying a person by using the image pattern of a face, retina, or iris have been developed recently, as disclosed in Japanese Patent Laid-Open No. 10-137220 (reference 1), Japanese Patent Laid-Open No. 2001-215109 (reference 2), WO86/05018 (reference 3), and Japanese Patent Laid-Open No. 7-115572 (reference 4), as well as apparatuses using a fingerprint of an identification target. Especially, the iris of a human eye is a muscular portion to adjust pupil dilation and has a pattern unique to an individual, like a fingerprint. It is practically impossible to forge the iris. The iris has a higher recognition accuracy than a fingerprint and can be identified in a noncontact state. Because of these advantages, personal identification apparatuses using the iris have recently been put into practical use.

A personal identification apparatus using an iris comprises an image sensing means (e.g., camera or video camera) for sensing an iris and inputting the image data and a collation determination means for processing the output from the image sensing means. The collation determination means collates a registered pattern (reference pattern) sensed by the image sensing means at the time of registration with a collation pattern (input pattern) sensed by the image sensing means at the time of collation in accordance with a predetermined collation algorithm and outputs the result.

To increase the collation accuracy of the personal identification apparatus, it is important to sense the registered pattern and collation pattern by the image sensing means under the same conditions. To do this, it is ideal to locate the identification target at the same position with respect to the image sensing means in registration and collation.

In a personal identification apparatus described in reference 1, the distance between an identification target and a video camera is calculated in synchronism with a zoom mechanism. The iris of the identification target is sensed by the video camera while irradiating his/her eye with light having an intensity corresponding to the distance.

An iris image inputting apparatus described in reference 2 comprises a stereoscopic display to display a 3D image and a 3D object generation means in order to guide the iris of an identification target to an optimum position. The 3D object generation means generates and displays a background object and optimum position object. The 3D object generation means also generates an eye position object based on the eye position of the identification target and displays it on the stereoscopic display.

The iris is guided to the optimum position by causing the identification target to move his/her eyeball such that the eye position object displayed on the display screen of the stereoscopic display matches the center of the optimum position object. A determination means checks whether the eye position object matches the optimum position object. When the eye position object matches the optimum position object, the determination means sends an extraction instruction signal. An iris pattern extraction means extracts the iris pattern on the basis of the extraction instruction signal.

However, the personal identification apparatus disclosed in reference 1 requires the zoom mechanism and the distance calculation unit to calculate the distance between the identification target and the video camera and is therefore expensive.

The iris image inputting apparatus disclosed in reference 2 also requires the stereoscopic display to display the 3D image and the 3D object generation means and is therefore expensive and bulky.

### SUMMARY OF THE INVENTION

It is an object of the present invention to provide a personal identification apparatus which allows an identification target to easily and properly guide the face or part of the face as an image sensing target into the focus range of an image sensing means.

In order to achieve the above object, according to the present invention, there is provided a personal identification apparatus comprising image sensing means for sensing at least part of a face of an identification target, collation determination means for collating image pattern information output from the image sensing means with registered pattern information of at least part of the face and outputting an authentication result, and recognition means for causing the identification target to recognize that at least part of the face is located in a focus range of the image sensing means, the recognition means comprising a point source, and a light-shielding member which is arranged between the point source and the identification target to set the point source in one of an invisible state and a visible state from the identification target only when at least part of the face is located in the focus range of the image sensing means and set the point source in the other of the visible state and the invisible state at another portion.

### BRIEF DESCRIPTION OF THE DRAWINGS

FIG. 1 is an exploded perspective view of a personal identification apparatus according to the first embodiment of the present invention;

FIG. 2 is a front view of the personal identification apparatus shown in FIG. 1;

FIG. 3 is a side view of the personal identification apparatus shown in FIG. 1;

FIG. 4 is a rear view of a transparent plate shown in FIG. 1;

FIG. 5 is a view for explaining an identification target sensing state;

FIG. 6 is a view for explaining the difference in visibility of the point source by light-shielding portions;

FIG. 7 is a view showing the relationship between the focus range and the proper iris region;

FIG. 8 is a block diagram of the main part of the personal identification apparatus shown in FIG. 1; and

FIG. 9 is a view showing the second embodiment of the present invention.

### DESCRIPTION OF THE PREFERRED EMBODIMENTS

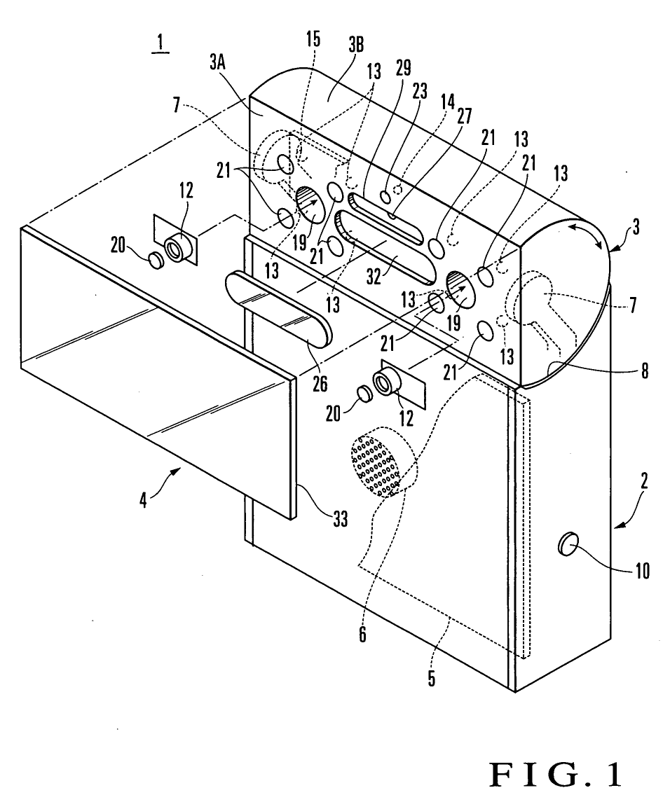

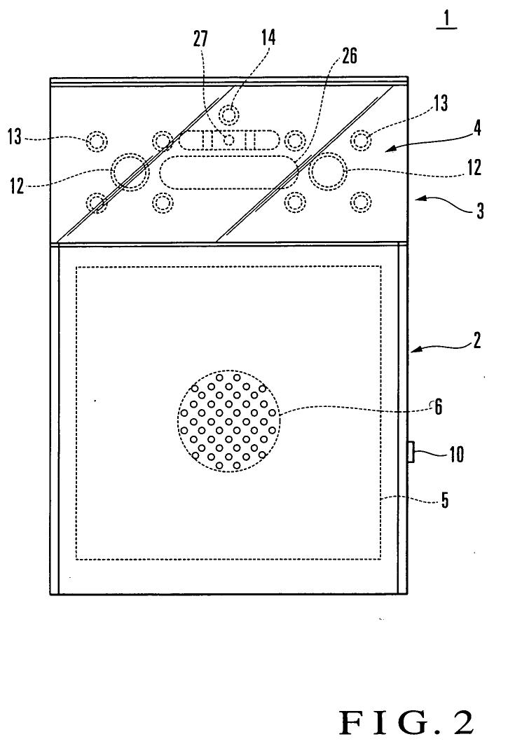

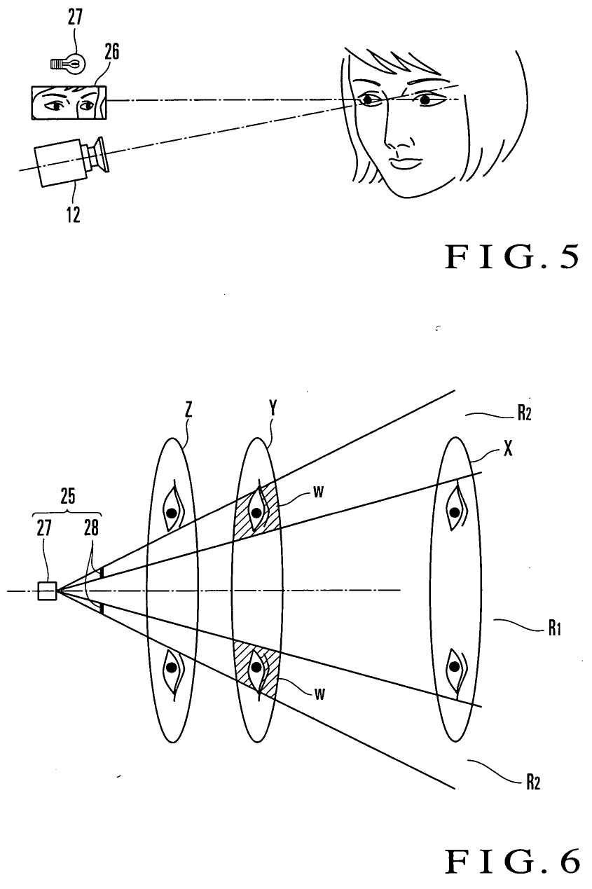

A personal identification apparatus according to the first embodiment of the present invention will be described below with reference to FIGS. 1 to 8. In this embodiment, the iris of an eye of an identification target is sensed as a collation target, and the iris pattern is identified by collating it with the iris pattern of a registrant registered in advance.

Referring to FIG. 1, a personal identification apparatus 1 is designed for wall-mount installation and comprises a body case 2 disposed in the vertical direction, a movable case 3 supported on the body case 2 to freely pivot about a horizontal axis, and a transparent plate 4 which covers the front surface of the movable case 3 and partially shields light.

The body case 2 has a thin box shape long in the vertical direction and incorporates a circuit board 5 and a speaker 6 for voice guidance of the mode state in iris collation. The circuit board 5 has a known collation determination circuit which collates a registered pattern sensed at the time of registration with the iris pattern of an identification target sensed by an image sensing means at the time of collation on the basis of a predetermined collation algorithm and outputs the result. A capture button 10 which should be operated by the identification target when his/her face is located in a proper iris region (to be described later) is attached to the side surface of the body case. The capture button 10 is provided in such a range and position that the identification target can operate it without moving the face when the face is located in the proper iris region (to be described later).

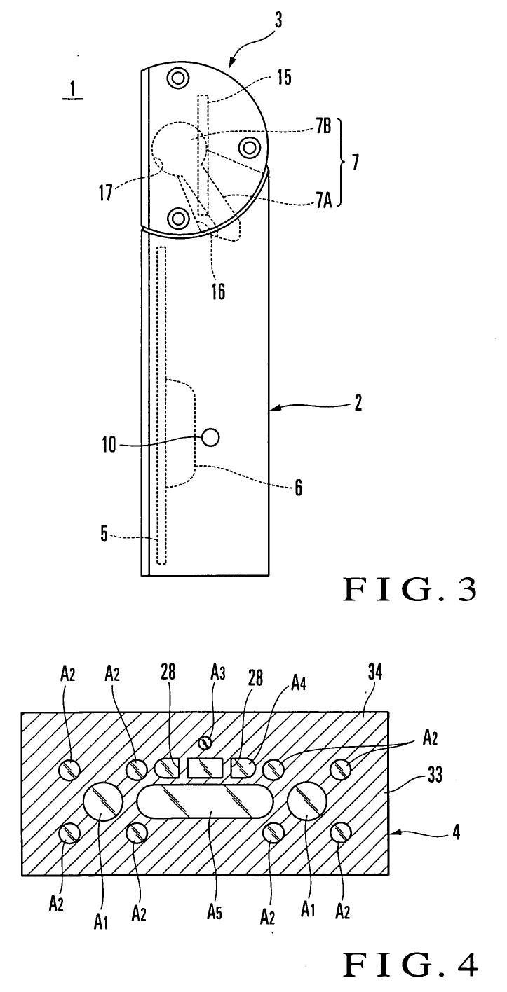

The body case 2 has a pair of support units 7 which axially and pivotally support the movable case 3. The upper ends of the support units 7 are inserted in the movable case 3. An upper plate 8 of the body case 2 curves in arc with a radius R such that the front end becomes lower than the rear end. The pair of support units 7 project upward from the upper plate 8. As shown in FIG. 3, each support unit 7 has a leg portion 7A and a disk portion 7B integrated with the upper end of the leg portion 7A.

The movable case 3 is long in the horizontal direction and has a D shape when viewed from the side. For this reason, the front surface of the movable case 3 is almost vertical. The rear surface curves in arc with almost the same radius as the radius of curvature of the upper plate 8 of the body case 2. The movable case 3 incorporates two image sensing devices 12 to sense the irises of the identification target, illumination light sources 13, a mode indicator light source 14 to indicate the mode state in iris collation by color, and a circuit board 15.

As shown in FIG. 3, the movable case 3 has sector-shaped grooves 16 which are formed in the inner surfaces of the two side plates to receive the leg portions 7A, and circular recessed portions 17 in which the disk portions 7B are slidably fitted. By the friction between the recessed portions 17 and the disk portions 7B, the movable case 3 can be locked at an arbitrary pivotal angular position. The pivotal angle of the movable case 3, i.e., the upper side of the front surface in the vertical direction is set to 30° to the rear side and about 10° to the front side.

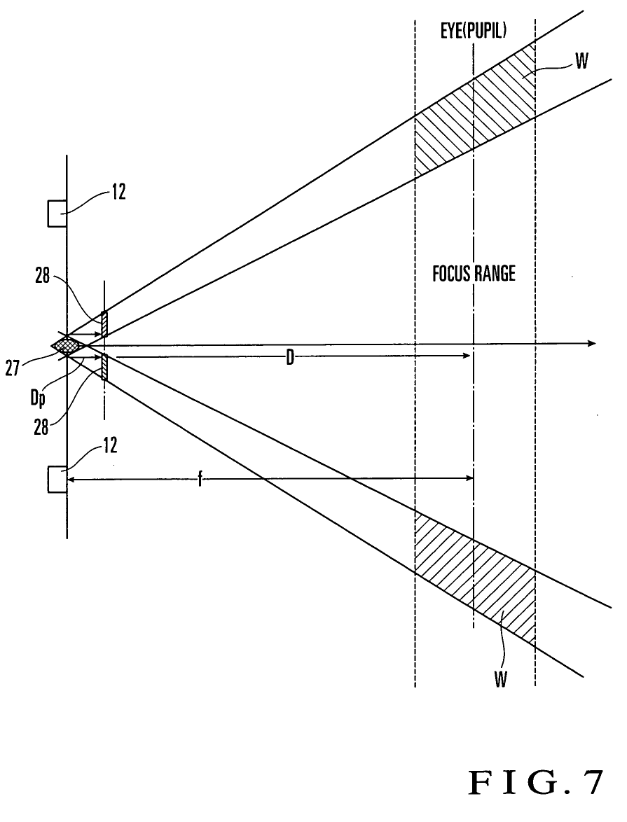

As the image sensing device 12, a digital camera using a CMOS image sensor or CCD as an image receiving element is mounted on the circuit board 15. The two image sensing devices 12 are accommodated in a pair of camera accommodation holes 19 formed in a front plate 3A of the movable case 3 to enable sensing of the irises of the eyes of an identification target. Filters 20 are arranged on the front surface side. Referring to FIG. 7, the focus range of the image sensing device 12 is about 3 to 4 cm.

As the illumination light source 13 of the image sensing device 12, e.g., an near-infrared LED is used. The number of the illumination light sources 13 can be arbitrary. In this embodiment, four illumination light sources 13 are provided for each image sensing device 12 and accommodated in four illumination light source holes 21 formed around each camera accommodation hole 19.

As the mode indicator light source 14, an LED capable of switching light emission to seven colors is mounted on the circuit board 15. The mode indicator light source 14 is visibly accommodated in a mode indicator hole 23 formed in the front plate 3A of the movable case 3. The mode indicator hole 23 is formed on the upper side at the center of the front plate 3A in the horizontal direction.

The movable case 3 has a mirror 26 and a recognition unit 25 which causes the identification target to recognize whether the irises of his/her eyes are present in the focus range of the image sensing devices 12.

As shown in FIG. 6, the recognition unit 25 includes a point source 27 and two light-shielding portions 28 located on both sides and in front of the point source 27. As the point source 27, an LED with a size of about 1 mm is mounted on the circuit board 15. The point source 27 is arranged in a point source hole 29 formed in the front plate 3A of the movable case 3 and is therefore visible from the front side through the transparent plate 4. The point source hole 29 is long in the horizontal direction and is formed on the lower side of the mode indicator hole 23.

The mirror 26 is used to cause the identification target himself/herself to recognize the vertical and horizontal shifts of the eyes and guide the face to a proper position. The mirror 26 is so long that the two eyes of the identification target can be seen in it when they are within the focus range of the image sensing devices 12. The mirror 26 is fitted and fixed in a mirror recess 32 which is long in the horizontal direction and is formed at the center of the front plate 3A of the movable case 3. The mirror recess 32 is located between the two camera accommodation holes 19 on the lower side of the point source hole 29.

Referring to FIG. 4, the transparent plate 4 formed from an acrylic resin plate has almost the same size as the front surface of the movable case 3. The transparent plate 4 has a light-shielding portion 34 formed by applying a light-shield coating 33 and translucent portions A₁ to A₅ except the light-shielding portion 34. The translucent portions A₁ to A₅ are formed at positions corresponding to the camera accommodation holes 19, illumination light source holes 21, mode indicator hole 23, point source hole 29, and mirror recess 32. A portion (hatched portion) except them indicates the light-shielding portion 34. The light-shield coating 33 may be applied to not the rear surface but the front surface of the transparent plate 4.

The translucent portion A₄ of the transparent plate 4, which corresponds to the point source hole 29, has the two light-shielding portions 28 formed in the vertical direction. The two light-shielding portions 28 are used to guide the eyes of the identification target to the focus range of the image sensing devices 12 in hatched regions (proper iris regions) W in FIGS. 6 (position Y) and 7. More specifically, the two light-shielding portions 28 are arranged between the point source 27 and the face of the identification target. In this state, the identification target looks straight at the point source 27 and moves the face in the fore-and-aft direction. On the basis of a distance Dp between the point source 27 and the light-shielding portions 28, the width of each light-shielding portion 28 itself, and the interval between the two light-shielding portions 28, if the identification target is located far from the point source 27, as indicated by a position X in FIG. 6, the eyes are located within an illumination region R₁ of the point source 27. Hence, the identification target can visually recognize the point source 27.

On the other hand, if the identification target approaches the point source 27 from the position X by a predetermined distance, as indicated by the position Y in FIG. 6, the eyes enter non-illumination regions R₂ so the identification target cannot visually recognize the point source 27. If the identification target further approaches the point source 27 from the position Y, as indicated by a position Z in FIG. 6, the eyes leave the non-illumination regions R₂ so that the identification target can visually recognize the point source 27. Using such optical characteristics, the width of each light-shielding portion 28 itself, the interval between the two light-shielding portions 28, and the distance from the point source 27 to the light-shielding portions 28 are determined in accordance with a focal length f and focus range of the image sensing devices 12. The proper iris regions W where the point source 27 is invisible are set within the focus range of the image sensing devices 12, as shown in FIG. 7.

As indicated by the position Y in FIG. 6, when the eyes of the identification target move into the focus range, and the point source 27 becomes invisible, the identification target can recognize that the eyes are guided to the proper iris regions W of the image sensing devices 12. To the contrary, when the eyes of the identification target move to the position X in FIG. 6, i.e., far away from the focus range, the point source 27 can be seen between the two light-shielding portions 28. When the eyes are located at the position Z in FIG. 6, i.e., too close to the point source 27, the point source 27 can be seen outside the light-shielding portions 28. In these cases, the identification target himself/herself can recognize that the eyes are out of the proper iris regions W of the image sensing devices 12. In FIG. 7, reference symbol D denotes a distance from the light-shielding portions 28 to the center of the focus range.

An identification target identification operation by the above-described personal identification apparatus 1 will be described next.

In identification, the identification target stands in front of the personal identification apparatus 1 and makes the face opposite to the movable case 3 such that the point source 27 and the eyes of the identification target come to the same level. If the movable case 3 tilts to the front or rear side and cannot be opposite to the face, the identification target moves the face upward or downward or manually pivots the movable case 3 in the fore-and-aft direction such that the movable case 3 is opposite to the face.

Whether the face and movable case 3 oppose each other or are shifted in the vertical and horizontal directions can be confirmed by looking at the mirror 26 with the eyes. More specifically, when the eyes that look at the mirror 26 can be seen at proper positions in the mirror 26, the face opposes the movable case 3 without a shift in the vertical and horizontal directions. If the eyes cannot be seen at the proper positions, the face is moved, or the movable case 3 is pivoted such that the eyes can be seen properly.

The eyes are moved and located in the proper iris regions W by moving the face in the fore-and-aft direction while keeping the face opposing the movable case 3. When the eyes enter the proper iris regions W, the point source 27 is shielded by the light-shielding portions 28 and becomes invisible. The identification target recognizes that the eyes enter the proper iris regions W and operates the capture button 10.

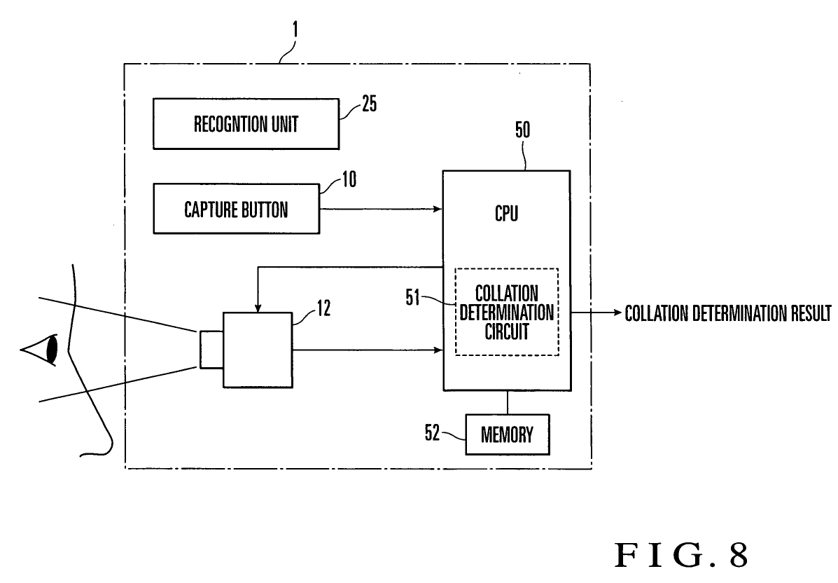

Upon detecting that the capture button 10 is operated, the CPU 50 shown in FIG. 8 sends a driving signal to the image sensing devices 12. The image sensing devices 12 sense the irises of the identification target in accordance with the driving signal from the control unit 50 and send the image pattern to the collation determination circuit on the circuit board 5. The collation determination circuit receives the image pattern of the irises and collates it with a registered pattern, which is registered in advance, on the basis of a predetermined collation algorithm, thereby authenticating the identification target.

In the above description, the collation determination circuit on the circuit board 5 executes the collation determination operation independently of the CPU 50. As shown in FIG. 8, the CPU 50 may have the function of a collation determination circuit 51. In this case, the collation determination circuit 51 of the CPU 50 executes the collation determination operation in accordance with the registered pattern an a determination program stored in a memory 52.

As described above, in the present invention, the recognition unit 25 includes the point source 27 and two light-shielding portions 28. When the point source 27 becomes invisible in accordance with fore-and-aft movement of the face, the identification target can recognize that the irises are guided to the proper iris regions W. For this reason, the apparatus can be manufactured at a low cost because no expensive circuits, electronic components, or display need to be used. The point source 27 is as small as an about 1 mm square. The two light-shielding portions 28 can be formed by a coating or film. Hence, the apparatus can be made compact because no special space is necessary.

Since the identification target can recognize by the mirror 26 whether the eyes are properly seen in the mirror, he/she can correct shifts in the vertical and horizontal directions while looking at the mirror 26.

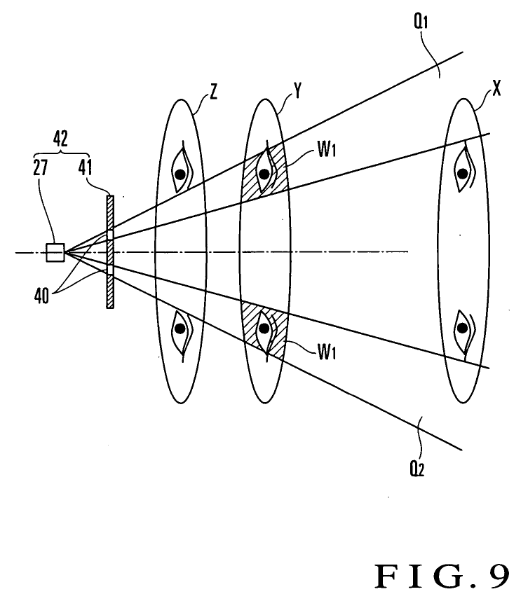

The second embodiment of the present invention will be described next with reference to FIG. 9. The second embodiment is different from the first embodiment in that a recognition unit 42 is formed by using a light-shielding member 41 having two translucent portions 40. The translucent portions 40 are used in place of the light-shielding portions 28 of the recognition unit 25 (FIG. 6). If the light-shielding member 41 itself is made of an opaque material, the translucent portions 40 are formed as holes (openings). If the light-shielding member 41 is made by forming a light-shielding film on a transparent member, the translucent portions 40 may be formed as holes or transparent portions without the light-shielding film. The light-shielding member 41 may be either an opaque member or a member made by forming a light-shielding film on a transparent member.

The light-shielding member 41 having the two translucent portions 40 formed at an interval narrower than that of the two eyes is arranged between a point source 27 and the face of an identification target who looks straight at the point source 27 with the eyes. At this time, the point source 27 may be visible through the translucent portions 40 or invisible depending on the width of the translucent portions 40, the distance between the point source 27 and the translucent portions 40, and the interval of the translucent portions 40. More specifically, when the eyes are far from the point source 27, as indicated by a position X in FIG. 8, they are located between illumination regions Q₁ and Q₂ of the point source 27. Hence, the point source 27 is invisible because it is shielded by the light-shielding member 41. When the eyes approach the point source 27 and enter the illumination regions Q₁ and Q₂ of the point source 27, as indicated by a position Y in FIG. 8, the point source 27 can visually be recognized through the translucent portions 40. When the eyes further approach the point source 27, as indicated by a position Z in FIG. 8, they move to the outside of the illumination regions Q₁ and Q₂ of the point source 27. Hence, the point source 27 is invisible because it is shielded by the light-shielding member 41.

The width and interval of the translucent portions 40 and its distance from the point source 27 are determined such that proper iris regions W₁ where the point source 27 is visible are set in the focus range of the image sensing devices. Hence, the irises of the identification target can be guided to the proper iris regions W₁, like the recognition unit 25 of the first embodiment.

Even in the recognition unit 42, only the point source 27 and light-shielding member 41 suffice. Hence, the same effects as in the above-described embodiment can be obtained.

The present invention is not limited to the above-described embodiments, and various changes and modifications can be made. For example, two image sensing devices 12 need not always be used, and a single image sensing device may be used. In this case, a half mirror is used as the mirror 26, and the image sensing device 12 is arranged on the rear side of the mirror. The light-shielding portions 28 may be semitransparent or be tinted to an appropriate color. The light-shielding portions 28 need not always have a band shape and may be, e.g., rectangular or circular. The point source 27 may blink instead of simply lighting up.

The present invention is applied to a personal identification apparatus which identifies an individual by using an iris pattern. However, the present invention can also directly be applied to an apparatus which identifies an individual on the basis of a face shape or retinal pattern.

As described above, according to the present invention, the identification target can recognize that the face or part of the face is located in the focus range of the image sensing means by a simple arrangement.

What is claimed is:

1. A personal identification apparatus comprising:
image sensing means for sensing at least part of a face of an identification target;
collation determination means for collating image pattern information output from said image sensing means with registered pattern information of at least part of the face and outputting an authentication result; and
recognition means for causing the identification target to recognize that at least part of the face is located in a focus range of said image sensing means,
said recognition means comprising:
a point source; and
a light-shielding member which is arranged between said point source and the identification target to set said point source in one of an invisible state and a visible state from the identification target only when at least part of the face is located in the focus range of said image sensing means and set said point source in the other of the visible state and the invisible state at another portion.

2. An apparatus according to claim 1, wherein said light-shielding member comprises two light-shielding portions which make said point source invisible from the identification target only when at least part of the face is located in the focus range of said image sensing means and make said point source visible at another portion.

3. An apparatus according to claim 1, wherein said light-shielding member comprises two translucent portions which make said point source visible from the identification target only when at least part of the face is located in the focus range of said image sensing means and make said point source invisible at another portion.

4. An apparatus according to claim 1, further comprising:
a body case; and
a movable case which is supported on an upper side of said body case to freely pivot about a horizontal axis and incorporates said point source and said light-shielding member.

5. An apparatus according to claim 1, further comprising a mirror to reflect eyes of the identification target.

6. An apparatus according to claim 1, further comprising a capture button which is operated by the identification target when at least part of the face is located in the focus range of said image sensing means,
wherein when said capture button is operated, part of the face of the identification target is sensed by said image sensing means.
